(19) United States
(12) Patent Application Publication
(10) Pub. No.: US 2019/0066252 A1
(43) Pub. Date: Feb. 28, 2019

(54) Method, system and apparatus for engaging golf swing platform business

(71) Applicant: Chiou-muh Jong, Ellicott City, MD (US)

(72) Inventor: Chiou-muh Jong, Ellicott City, MD (US)

(21) Appl. No.: 15/683,712

(22) Filed: Aug. 22, 2017

(51) Int. Cl. G06Q 90/00; A63B 69/36

(52) U.S. Cl. CPC G06Q 90/00; A63B 69/3661

(57) ABSTRACT

A business model to benefit golfers who like to practice swings at uneven lie conditions on swing platform, the owners of platforms and the driving range owners is invented. By renting platforms which are having different lie conditions through rotating with minimum effort by the users, the platforms can be optimally used. The platform owners can get profit through rental agreement without the need to sell their platforms, while the driving range owners can share the profit from the rental business by installation of platform without further investment.

### 1. FIELD OF INVENTION

The present invention relates to a new business model for golfers to practice swinging balls on uneven fairway conditions on a golf swing platform installed in a swing location in a driving range. The owner of the platform is typically not the same as the owner of driving range such that a business arrangement is required to be set up in order to provide an affordable service for golfers and fair profit sharing for the driving range owner and golf swing platform owner.

### 2. BACKGROUND OF THE INVENTION

Golf is one of the top sports in the United States and some other countries. The United States alone may have over fifty million golf population. As popular as it is, however, golf skills are not easy to master. We can see so many driving ranges open year long for golfers to polish their skills. The most difficult skills to master are those to hit the balls on uneven ball lie conditions; the balls may lie on uphill, downhill, sidehill up and sidehill down conditions and each condition take long time to practice before one can skillfully hit the balls to get satisfied result.

Although the professional golf training schools are pretty popular and they typically use teaching tools to train golf students for improving their skills, but they still need long term practice to improve their skills. Unfortunately, most swing locations in driving ranges do not offer any practice device for golfers to practice the most difficult skill set in the golf game on the basis of pay for service per visit or additional charge on membership.

It has always been a hot topic for inventors to create good methods and practical devices to help a golfer to improve his skill in hitting ball on various fairway surfaces. To see this, all one needs to do is to search USPTO patent database, using “golf” as keyword in title field and “platform” in description field, one will find a lot of patents about platforms for improving swing on variety of hitting surfaces. For example, U.S. Published Nos. 20020187848, 20020128084, 20020119827, 20010044344, 20010034272, U.S. Pat. Nos. 6,514,152, 6,450,895, 5,944,615, 5,720,670, 5,558,334, 5,527,042, 5,470,074, 5,358,251, 5,340,111, 5,046,741, 5,005,837, 4,875,684, 4,331,332, 4,279,420, 3,693,979, 3,639,923, 3,633,918, 3,633,917, 3,430,964 and 2,937,875 published as early as 56 years ago, are all related to improving golfer's skill in hitting ball on surfaces of various inclinations. This fact reveals that golf swing is really a difficult skill to learn, it needs practice after practice to master, and that for the last forty plus years, the enthusiasm to invent an ideal device improving golf swing skill never decays.

In his U.S. Pat. No. 6,921,342, Jong showed a design for how to build a low cost swing platform to practice various ball lie condition. It was a good idea to use gaslift as a handy, commercially ready component to lift the platform easily for different lie condition on the platform when the platform is rotated. However, the use of gaslift has its disadvantage in winter time when a lot of golfers tried to polish their skills in the off season. Gaslift does not work well when it exposes to cold ambient temperature because the inert gas inside just can't expand as much as in the summer time.

Another disadvantage with the platform tilting a slope similar to the one in Jong's U.S. Pat. No. 6,921,342 is that, a golfer practicing on it may have the danger of falling down to ground when stepping out of the platform at the side of platform where it is high above the ground. Although such kind danger threat is not uncommon in commercial products and is not as severe as a lot of popular merchandises such as bicycles and ladders owned and accepted by a lot of people, the platform with such danger threat may get lawsuit if any golfer falls down from the platform. The driving range owners may try not to use such kind platform if they can to avoid being suited.

While most inventors are aiming to create affordable platforms for individuals and golf driving ranges to own and use, it should be pointed out that, a business of rental of affordable platforms between device owners and driving range owners may benefit everybody, includes the golfer who use the rental platform the most. In the current business setting, it is very easy for driving range owners to provide swing locations for installing platforms at minimum cost. The device owners, when providing their platforms in the form of rentals, can share the revenue of the usage charges, paid by golfers when they use the platforms, with the driving range owners without the need to sale their platforms to individual golfers of whom not many of them are affordable anyway. So golfers get practice on a platform without buying the platforms, device owners maximize the usage of their platforms without selling them and range owners enjoy providing platform service without further investment except allowing some of their swing stations for the installation of platforms, which may cost nothing in most cases.

As an example, the rental agreement between the two businesses may be as simple as charging extra fee on every bucket the golfer tries to use for practicing on the platform. In current driving range business pattern, charging $4 to $10 for every bucket to hit the ball on a flat golf mat is a common practice. Charging additional $2.00 as the platform usage fee will be a reasonable cost and reasonable profit for both business owners.

### 3. Summary of Invention

A business method is invented to benefit golfers who like to polish their swing skills on uneven ball lie conditions, platform owners who look to maximize the profit of the platforms they own and the driving range owners who also try to get more profit for their already existed investment by providing more meaningful service to the golfers. Therefore the main object of the current invention is to provide an affordable service in public area for golfers to improve their driving ball skill when facing uphill, downhill, sidehill up and sidehill down ball lies without buying an expensive platform.

Another object of the current invention is to provide a business mechanism such that the platforms invented and designed to improve the swing skill of golfers can be optimally used.

A further object of current invention is to, through a rental business mechanism, take advantages of widely accepted golf practice business locations such as driving ranges to provide affordable skill improving services by accepting golf platforms owned by other business organizations with minimum investment.

Yet another object of the current invention is to provide a business model such that device owners can concentrate on platform function improvement without worry about selling them to individual golfers and other buyers.

Yet a further object of present invention is to make driving ranges attract more business due to the platform services they provide attract more visits of golfers for practice.

And finally, it is also the object of current invention to provide a platform ideal for being used in the business of renting platforms so that the cost is manageable for device owners to manufacture their devices for the rental business.

### 4. BRIEF DESCRIPTION OF DRAWINGS

FIG. 1 shows a golfer is hitting a ball on a platform with uneven contour surface, while FIG. 2 shows detailed structure of the platform.

FIG. 3 illustrates how balls sitting at different locations of the platform will simulate the uphill, downhill, sidehill up and sidehill down condition for the user shooting to different directions.

FIG. 4 is a flowchart showing how the owner of platforms initiates contacts with driving range business to form business joint ventures for providing platform rental service.

### 5. DETAILED DESCRIPTION OF DRAWINGS

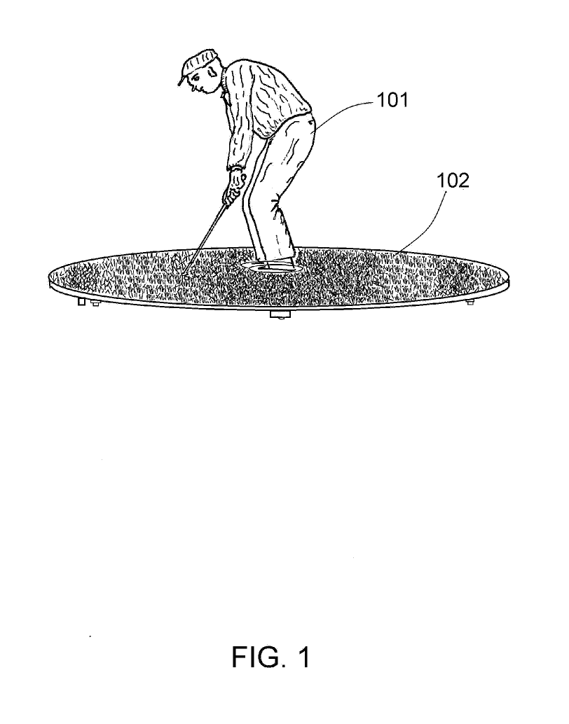

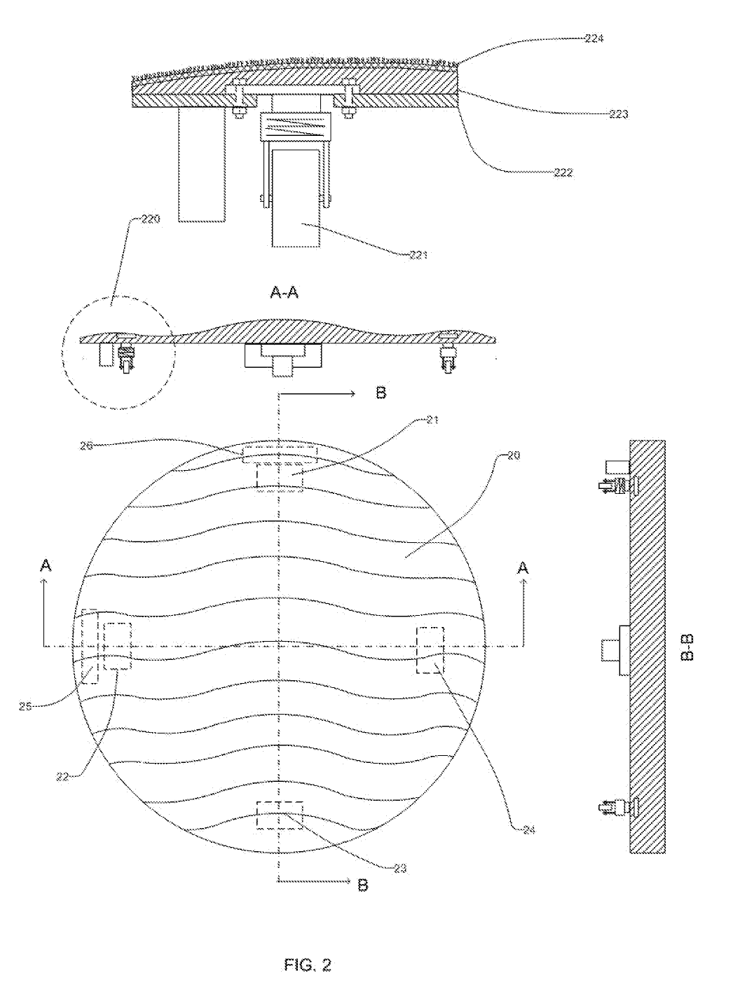

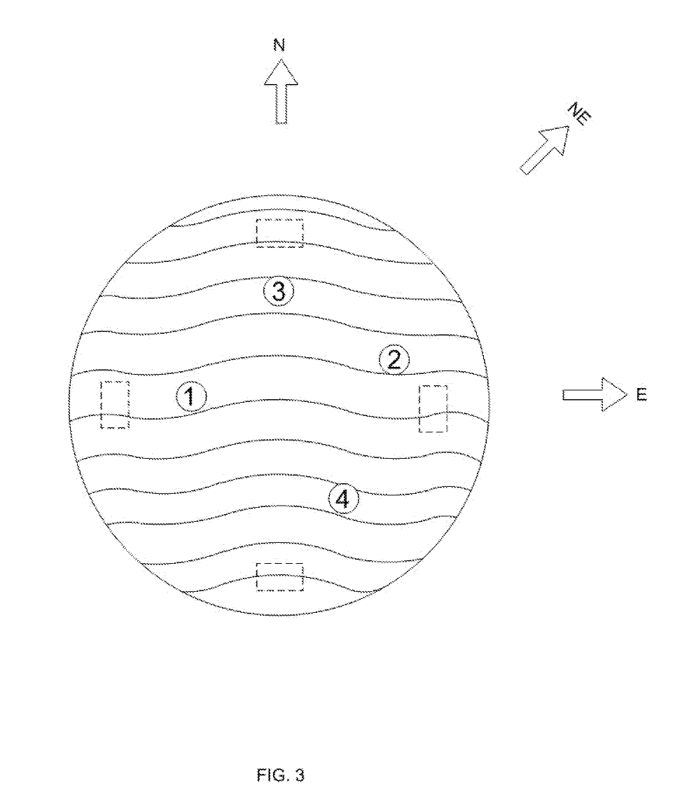

In FIG. 1, golfer 101 is hitting a ball on a platform 102 which is installed in a swing station in a typical driving range. The uneven contour on the platform 102 shows that an uneven contour which can be seen more clearly in details on FIG. 2. To properly operate the platform for hitting all kind combinations of hitting balls simulating uphill, downhill, sidehill up and sidehill down lie conditions, the golfer need to step down to ground area and rotate the platform for desired combinations of ball lie conditions. FIG. 3 shows how the hitting directions relate to the ball lie conditions with some balls lie on different locations.

A preferred size of platform embodied in current invention is 6′ in diameter and circular in shape, although octagon is actually fine as far as serving the purpose of current invention. The diameter of 6′ is a size judged from the combination factors of big enough platform space for providing enough contour variations, the size of typical swing stations in most driving ranges and the handiness of platform to be moved around for installation. The platform should be built with strong structure to withstand heavy golfers swinging on its top without problem.

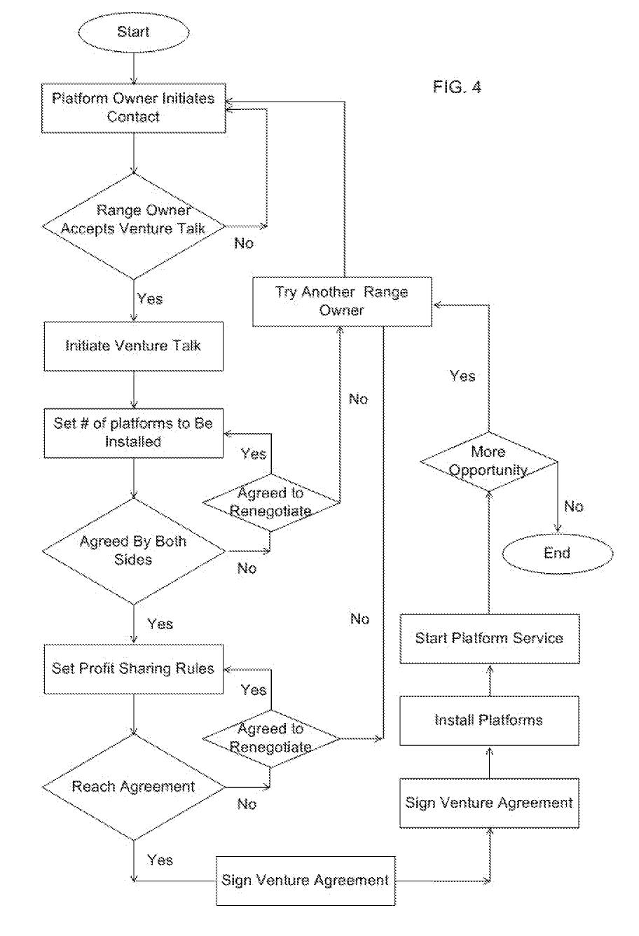

When a driving range establishes a business agreement with a platform provider for some of its swing stations according to a process described in FIG. 4, the driving range is ready to provide platform swing business for customers who are eager to improve their skill to hit ball at uneven lie fairway conditions. The customer golfer will need to pay extra amount of fee for using the platform according to their accepted rule. The golfer may pay on the basis of bucket by bucket of hitting balls, or he or she can prepay on membership arrangement.

Preferable embodiment of a platform suitable venture business for a platform owner and a driving range owner is detailed in FIG. 1 and FIG. 2. Which show that the platform is lifted up slightly by two of the four casters in order to make the platform rotatable. Specifically in FIG. 2, the platform 20 has four non-swivel casters 21, 22, 23 and 24 installed under the platform, with each of them separated by a 90 degree angle. Of the four casters, 21 and 22 are spring-loaded casters while 23 and 24 are casters without springs. The four casters are arranged so that they can only roll in tangential direction, which prevent the translational movement of the platform. In other words, the platform is allowed to rotational movement only.

The springs in the casters 21 and 22 function to lift half side of the platform up so that the two legs 25 and 26 are off the ground by half of an inch or so, which, together with the two casters 23 and 24, make the platform totally sitting on the four casters for easy rotation. The golfer rotates manually the platform to an angle he desires to practice and then step on the platform. When the golfer is on the platform, the springs in the casters 21 and 22 will be compressed or elongated so that the two legs 25 and 26 will touch the ground completely, a situation that legs 25 and 26 will prevent the platform from any translational or rotational movement, thus securing the platform to be a sturdy structure sitting on the ground for practice without safety concern. The four casters are of non-swivel type so that their wheels can only move in tangential direction, which implies that the platform can only be rotated with no translational movement is allowed.

The spring in the casters 21 and 22 should have a spring constant large enough to lift half side of the platform up to 0.5″ so that the platform is easy to be rotated by the user. The spring constant should also be small enough such that it cannot sustain the half of the combined weight of the platform and a human being. In other words, if the weight of the platform is eighty pounds and it is designed to be used for all golfers above 100 lbs, the spring constants for casters 21 and 22 should have a combined constant such that when the load is less than 40 lbs, it will be strong enough to lift platform up to half an inch and if the load is over 40+100/2 lbs=90 lbs, the two legs 25 and 26 of the platform will touch the ground to make the platform not movable. Because the two springs are equal, so each constant is just half of the combined constant value.

In a slightly different embodiment, one can make all four as spring-loaded casters without much difference in operation. In fact, similar mechanism with 2 spring-loaded casters among four of being used has been widely used in heavy ladders with four casters for shelf stocking in the hardware or department stores where the workers need to move ladders around and secure them at any location with two spring-loaded casters being used as the control mechanism to touch ground or not.

Casters with steel wheels will be preferred for a platform sitting outdoor all year long. The height of a commercially available spring-loaded casters suitable for the embodiment of current invention are typically in the range between 5″ to 6″, so it is a good design to have some portion of the casters poked out of the platform such that the height of platform can be reduced to under 4″, which makes the platform look like sitting on the ground and hence eliminating the chance of falling down during a practice on the platform. In FIG. 2, the partial portions of all four caster structure are shown to be buried inside the contour structure so that they are not visible and will be shown later in more details. More importantly, they will not block the golf shot which might otherwise be dangerous to the practicing golfer.

Section A-A and B-B separately show the section views of the platform structure. In this particular embodiment, section view A-A shows the curved contour in the center strip of the platform. Along with the platform board structure, spring-loaded caster 220 has been shown in an augmented view, which further shows spring-loaded caster 221 being securely fixed to the platform structure board 222. Layer 223 is an intermediate structure responsible for the contour shape of the platform, which can easily be manufactured using wood or plastic as structure material. On the top of 223, the layer 224 is the golf mat which simulates the glass on fairway for golf swing. The slope on the contour surface should not be too steep, as it needs to hold balls on the surface from rolling without touching them.

In FIG. 3, four golf balls are shown on the platform with different locations for the illustration of different lie conditions. The contour on the surface of the platform is shown to have three bump strips at left side, center and right side of the platform. In-between left side and center bumps and between center and right side bumps are valley regions. Together they form the simulation of typical fairway uneven conditions brought to a small area on the platform. It can be seen that ball 3 is on the top of the bump surface, while 1, 2 and 3 are sitting a little off the valley.

For a right-hander who is standing on the platform trying to hit the ball toward north direction, the location he or she stands is clearly lower than the ball in elevation. So the right-hander needs to adjust himself or herself to hit such an elevated ball and can do that for many times until he or she get used to hit a ball with higher elevation. It should be noted that, because of the symmetry nature of the contour surface, a left-hander will have the same lie condition under this particular ball location, but will not be necessary true for other locations.

Alternatively, when the right-hander tries to practice hitting ball 2, he or she is having an elevated standing location as compared to ball lie and self posture adjustment is necessary in order to hit the ball with good impact.

Ball 1 and ball 4 locations give yet another different lie conditions. In particular, ball 1 location will give the right-hander a chance to practice sidehill up lie condition, while ball 4 location gives sidehill down condition. All in all, the curvature distribution on the platform can provide a golfer standing on the platform with enough variations to practice uphill, downhill, sidehill up and sidehill down lie conditions when a golfer stands facing to the north.

Of course, when facing to east, as illustrated in the FIG. 3, the golfer can practice more different lie conditions. As compared to facing north, the golfer will encounter standing a situation where he or she stands at a slope up condition when hitting ball 3. Standing when trying to hit at ball 1, 2 and 4 locations are different too, as compared to facing north. This certifies that the platform can provide many different combinations of ball lie and standing conditions to practice hitting balls.

If the golfer faces to the northeast direction, conditions between facing north and east will be mixed together to have even more variations of ball lie conditions for practice.

When such platform is installed at a swing station in a driving range, the golfer can only hit golf ball in one direction. So the platform needs to be rotatable in order to get all the variations of ball lie and standing conditions.

FIG. 4 dictates the joint venture for the business to provide platform practice service to golfers who like to practice shots on various ball lie conditions. In current driving range business, there are a lot of them have sitting golf professionals to give various training courses or lessons, which use different teaching tools including platforms for training hitting balls at different lie conditions. However, almost all the driving ranges own the training tools and the students use them not through paying for each bucket or memberships, but through training fee for the right to use the tools.

So, naturally, it would be the interest of platform owners to initiate the joint venture, although it is also possible that driving range owner foresee the benefit of using a special type of training tool and initiate similar joint venture with the training tool. In FIG. 4, a flowchart is drawn with the assumption that an inventor or platform owner trying to promote his or her platform to driving ranges for the joint venture.

To start the business of renting platforms to drive range business, affordable individual golfers and organizations with big empty space for hitting the balls, mostly the owner of the platform need to initiate contact to one of them as his targeting partner-to-be, which is probably the most successful local driving range business. If this first targeted driving range or the like responses positively and agrees to discuss the joint venture, then the two sides start venture talk. Otherwise, there is no point to continue and the platform owner needs move on to switch to another target to initiate a fresh contact, as indicated on the flowchart in FIG. 4.

Once the venture talk starts, the first thing to be considered will be the number of platform to be installed in the driving ranges or the like. The number will of course depend on the capacity of the driving range. For a big one, it may have near 100 swing locations. The driving ranges associated with golf courses typically have around 20 to 50 swing stations, depends on golf business, location and their management style. In order to make the platform service as a demanding commodity, owners of both sides will tend not to install too many units. So it could be a negotiation of between 1 to, say, 5 units, with the goal to optimize the revenue such service will generate for each side of the business. In the early stage of such service, most owners will probably start with one platform and see how the demand goes. If, however, some driving range businesses have found that such business is indeed in high demand, then the number of platforms set will gradually reflect their capacities and the platform service ventures will gradually sustain to survive and to be profitable.

After the number of platform is settled, both sides will need to talk about the profit sharing scheme which is agreeable by them. From current driving range practice, it is reasonable to charge additional fee, for example, $2.00 for each bucket of golf balls consumed on the platform, but some driving ranges in some particular locations may have different amount to charge and they need to settle for it. Although the charge of platform usage fee in addition to the bucket fee without using platform is mainly aiming to those customers who pay their using fees bucket by bucket, it can obviously be extended to those long term customers who own memberships by imposing same ratio of additional fee for each bucket they consume at the swing stations.

After both sides agree on the charge on the usage fee for the platform, they need to settle for the share of their profit on the usage fee. As a fair start, they can split the usage fee to two halves and each one of them. The final agreed term on the profit sharing may depend on the responsibility of platform maintenance and other issues. If both sides reach an agreed number, then the joint venture is roughly formed. Otherwise, it will either renegotiate or give up for contact to another driving range or the like.

Obviously, the joint venture talk is more complicated than the two major factors suggested in FIG. 4. Other factors such as the maintenance responsibility, insurance issue, and payment schedule and so on still need to be addressed in the talk before a final agreement can be signed. FIG. 4 serves as an explanation flowchart and those additional factors are considered to be minor as compared to the number of platforms and profit sharing, so they are intentionally skipped in the flowchart for simplicity.

While present invention has been shown, described and illustrated in detail for illustrative purpose, it should be understood by those skilled in the art that equivalent changes in form and detail may be made therein without departing from the true spirit and scope of the invention as disclosed in the accompanying claims.

I claim:

1. A method for the business of platform rental service for practicing golf swings on uneven ball lie conditions comprising the steps of:
a. engaging a joint venture talk between a platform business unit and a golf driving business unit
b. providing a golf swing platform by the platform business unit,
c. providing a swing station by the golf driving range business unit,
d. installing the golf swing platform on the swing station,
e. setting up a service fee schedule agreed by the platform business unit and driving range business unit,
f. setting up a rental agreement for the golf swing platform agreed by the platform business unit and driving range business unit, and
g. setting up a profit sharing scheme based on service fee schedule agreed by the platform business unit and driving range business unit, whereby a swing station for a golfer to practice golf swings under a plurality of lie conditions and a plurality of golfer standing conditions is available according to the service fee schedule.

2. The golf swing platform according to claim 1 is capable of providing, when manipulated by an user, a plurality of lie conditions including downhill, uphill, and sidehill down, sidehill up in the swing direction.

3. A system for the business of platform rental service for golfers to improve skill of swings on uneven ball lie conditions comprising:
a. a golf swing platform provided by a platform business unit,
b. a swing station provided by a golf driving range business unit for installing the golf swing platform,
c. a service fee schedule for the service of platform swing business agreed by the platform business unit and the driving range business unit,
d. a rental agreement for the golf swing platform agreed by the platform business unit and driving range business unit, and
e. a profit sharing scheme agreed by the platform business unit and driving range business unit, whereby the swing station for a golfer to practice golf swings under a plurality of lie conditions and a plurality of golfer standing conditions is available according to the service fee schedule.

4. The golf swing platform according to claim 3 is capable of providing, when manipulated by a golfer, a plurality of lie condition including downhill, uphill, and sidehill down, sidehill up in the swing direction.

5. An apparatus for providing platform rental business comprising:
a. a golf swing platform owned by a platform business unit,
b. a swing location provided by a golf driving range business unit to host the golf swing platform renting from the platform business unit and
c. a business agreement for rental of the golf swing platform, service fee schedule and profit sharing between platform business unit and driving range business unit, whereby a swing location for practicing golf swings under a plurality of lie conditions and a plurality of golfer standing conditions is available for a golf customer.

6. The apparatus according to claim 5, wherein said golf swing platform further comprising a layer of contoured golf mat simulating a plurality of uneven fairway conditions.

7. The golf swing platform according to claim 5 further comprising a mechanism to lift said golf swing platform off the ground for easy 360 degree rotation to any angle for desired contour condition when no golfer is standing on said golf swing platform and to lock said golf swing platform on the ground to prevent said golf swing platform from any rotational or translational movement when a golfer is standing on said golf swing platform in order to maintain sturdy condition for golf swing.
